(19) United States
(12) Patent Application Publication
(10) Pub. No.: US 2002/0027394 A1
(43) Pub. Date: Mar. 7, 2002

(54) Index detection mechanism generating index signal indicating one rotation of sensorless spindle motor

(75) Inventor: Munehisa Haitani, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 09/944,620

(22) Filed: Aug. 30, 2001

(30) Foreign Application Priority Data
Sep. 5, 2000 (JP) 2000-268990

(51) Int. Cl. H02K 11/00

(52) U.S. Cl. 310/66

(57) ABSTRACT

The present invention provides an index detection mechanism which forms plural magnetizing parts on a bottom of an outer periphery of one face of a rotor of a sensorless spindle motor, forms a conductive pattern of pulse train shape on a substrate disposed in proximity of the one face of the rotor in opposed relation to the magnetizing parts, detects magnetic flux changes caused by rotations of the magnetizing parts during rotations of the rotor as counter electromotive force in the conductive pattern of pulse train shape, and delivers the detected output as an index signal, wherein the plural magnetizing parts are formed so that magnetic field strength in a direction of an outer periphery of the rotor changes stepwise between two opposing points of the rotor, wherein the conductive pattern is formed into a pulse train shape corresponding to the stepwise changes of the magnetic field strength, and wherein an index signal is delivered from the conductive pattern each time the rotor makes one rotation.

### BACKGROUND OF THE INVENTION

1. Field of the Invention

The present invention relates to an index detection mechanism, and more particularly to an index detection mechanism that generates an index signal indicating one rotation of a sensorless spindle motor when a disk-type recording medium such as a floppy disk is rotated using the sensorless spindle motor.

2. Description of the Prior Art

Generally, recording/reproducing apparatuses using disk type recording media for information recording and reproducing use a spindle motor for rotationally driving the disk type recording media. A rotation state of the spindle motor is correctly controlled using various types of rotation control mechanisms, including an index detection mechanism, a rotation position control mechanism, and a rotation smoothing control mechanism called a frequency generator (FG).

The index detection mechanism generates one index signal each time the spindle motor makes one rotation, and provides an indication that the spindle motor has made just one rotation (360-degree rotation) in a period between the generation of one index signal and the generation of the next index signal.

The rotation position control mechanism generates plural position control signals for correctly controlling a rotation position of a spindle motor, and controls a rotation position of the spindle motor by detecting a generation timing of these position control signals.

The rotation smoothing control mechanism generates plural rotation control signals to smooth change states of rotation speeds of a spindle motor and performs control so as to smooth change states of rotation speeds of the spindle motor by detecting signal waveforms of these rotation control signals.

FIGS. 3A, 3B, and 3C, and FIGS. 4A to 4C are drawings showing the configuration of major portions of different types of known rotation control mechanisms in a spindle motor; FIG. 3A is for the index detection mechanism, FIGS. 3B and 3C are for the rotation position control mechanism, and FIGS. 4A to 4C are for the rotation smoothing control mechanism.

As shown in FIG. 3A, the index detection mechanism has one minute magnet 3₂ mounted on an edge of an outer periphery of a rotor 3₁ of a spindle motor and a one hole element (magnetic sensor) placed in vicinity of the edge of the outer periphery of the rotor 3₁.

The index detection mechanism roughly operates as follows. When the rotor 3₁ of the spindle motor rotates, the minute magnet 3₂ mounted on the edge of the outer periphery of the rotor 3₁ also rotates along with the rotor 3₁. As long as the space between the minute magnet 3₂ and the hole element 33 is wide, since the hole element 33 hardly senses the magnetic field of the minute magnet 3₂, no signal is outputted from the hole element 33. On the other hand, as shown in FIG. 3A, when the rotor 3₁ rotates so that the minute magnet 32 nears the hole element 33, the hole element 33 senses a change of magnetic fields caused by the nearing minute magnet 3₂ with the result that an index signal is delivered from the hole element 33. Thereafter, when the rotor 3₁ rotates so that the space between the minute magnet 3₂ and the hole element 33 becomes wide again, the hole element 33 senses little the magnetic field of the minute magnet 3₂ and no index signal is outputted from the hole element 33.

Although the known index detection mechanism is described using an example of using the hole element as a magnetic sensor, a usable magnetic sensor is not limited to the hole element 33 and an inductance element may be substituted as a magnetic sensor for the hole element 33.

As shown in FIGS. 3B and 3C, the rotation position control mechanism has circular magnets formed on the bottom of an outer periphery of one face of the rotor 3₁ of a spindle motor so that plural successive magnetizing parts 34₁, 34₂, . . . , 34₁₂ are formed by magnetizing the sides of the circular magnets, and three hole elements (magnetic sensors) 35₁, 35₂, and 35₃ are placed in the vicinity of the plural magnetizing parts 34₁, 34₂, . . . , 34₁₂. The magnetizing parts 34₁, 34₂, . . . , 34₁₂ are formed so that the magnetizing polarities of adjacent portions of two adjacent magnetizing parts are the same and the magnetizing parts 34₁, 34₂, . . . , and 34₁₂ are equally spaced in the outer periphery. The three hole elements 35₁ to 35₃ are equally spaced in a circumferential direction.

The rotation position control mechanism roughly operates as follows. When the rotor 3₁ of the spindle motor rotates, the magnetizing parts 34₁ to 34₁₂ mounted on the outer periphery of the rotor 3₁ also rotate along with the rotor 3₁. The three hole elements 35₁ to 35₃ each detect a position control signal each time a same polarity portion formed in the boundary between two magnetizing parts nears. The amplitude of the position control signal generated becomes the largest when the same polarity portion comes nearest, and becomes smaller as the same polarity portion moves away from the nearest position. The polarity of the position control signal generated at this time becomes one polarity (e.g., positive polarity) when the N pole of the same polarity portion nears, and becomes another polarity (e.g., negative polarity) when the S pole of the same polarity portion nears.

Next, as shown in FIGS. 4A to 4C, like the rotation position control mechanism, the rotation smoothing control mechanism has circular magnets mounted on a bottom face of an outer periphery of one face of the rotor 3₁ of a spindle motor so that plural successive magnetizing parts 36₁, 36₂, . . . , and 36₁₂ are formed by magnetizing the bottom faces of the circular magnets, and on a substrate 37 disposed in opposed relation to the face of the rotor 3₁ plural conductive patterns 38 of a predetermined shape each, e.g., comprised of a pulse train of a high repetitive cycle, are formed at positions corresponding to the plural magnetizing parts 36₁ to 36₁₂.

The rotation smoothing control mechanism roughly operates as follows. When the rotor 3₁ of the spindle motor rotates, the magnetizing parts 36₁ to 36₁₂ formed on the bottom of the outer periphery of the rotor 3₁ also rotate along with the rotor 3₁. At this time, of the plural conductive patterns 38 formed on the substrate 37, a position control signal having a relatively large amplitude is generated in a conductive pattern 38 to which a same polarity portion formed between two adjacent magnetizing parts is nearing, and on the other hand, a position control signal having a relatively small amplitude is generated in a conductive pattern 38 from which the same polarity portion is moving away.

Recently, there has been an increasing demand for the miniaturization of various electronic control apparatuses such as recording/reproducing apparatuses to effectively use the limited apparatus capacity. To satisfy such a demand for miniaturization, in a recording/reproducing apparatus, a so-called sensorless spindle motor control system has been adopted which employs a miniaturized spindle motor and need not use magnetic sensors for rotation control of the miniaturized spindle motor. The sensorless spindle motor control system detects a rotor rotation position by detecting counter electromotive force produced in a stator coil during operation of a spindle motor, that is, detects a rotation position of the spindle motor and controls the rotation of the spindle motor by detecting the rotation position. The adoption of the sensorless spindle motor control system eliminates the need to use the three hole elements 35₁ to 35₃ used in the known rotation position control mechanism, contributing to the miniaturization of the apparatus accordingly.

In this case, in the known sensorless spindle motor control system, even if counter electromotive force produced in a stator coil is detected, a position control signal cannot be obtained immediately from the detected output. However, even if a position control signal cannot be obtained, the rotation of the spindle motor can be controlled, except that rotation speeds of the spindle motor cannot always change smoothly. Although the sensorless spindle motor control system is preferably in terms of operation provided with the rotation smoothing control mechanism, the rotation smoothing control mechanism maybe omitted unless smooth changes in rotation speeds of the spindle motor are particularly important.

Although the known sensorless spindle motor control system can eliminate the three hole elements 35₁ to 35₃ used in the known rotation position control mechanism, even if counter electromotive force produced in the stator coil is detected, an index signal cannot be obtained immediately from the detected output. Hence, a known index detection mechanism must be used to obtain the index signal, and therefore the one hole element 33 used in the index detection mechanism cannot be eliminated. i Thus, although the above-described known sensorless spindle motor control system eliminates the three hole elements 35₁ to 35₃ used in the rotation position control mechanism, since the hole element 33 used in the index detection mechanism cannot be eliminated, it can be said that it is still insufficient to miniaturize the apparatus regarding the index detection mechanism.

### SUMMARY OF THE INVENTION

The present invention has been made in view of the above circumstances and provides an index detection mechanism that can contribute to the miniaturization of an apparatus in the use of the sensorless spindle motor control system.

An index detection mechanism of the present invention forms plural successive magnetizing parts on a bottom of an outer periphery of one face of a rotor of a sensorless spindle motor, forms a conductive pattern of pulse train shape on a substrate disposed in proximity of the one face of the rotor in opposed relation to the plural magnetizing parts, detects magnetic flux changes caused by rotations of the plural magnetizing parts during rotations of the rotor as counter electromotive force in the conductive pattern of pulse train shape, and delivers the detected output as an index signal, wherein the plural magnetizing parts are formed so that magnetic field strength in a direction of an outer periphery of the rotor changes stepwise between two opposing points of the rotor, wherein the conductive pattern is formed into a pulse train shape corresponding to the stepwise changes of the magnetic field strength, and wherein one index signal is delivered from the conductive pattern each time the rotor makes one rotation.

According to this method, plural successive magnetizing parts are formed on a bottom of an outer periphery of one face of a rotor of a sensorless spindle motor; a conductive pattern of pulse train shape is formed on a substrate disposed in proximity of the one face of the rotor face in opposed relation to the plural magnetizing parts; the plural magnetizing parts are formed so that magnetic field strength in a direction of an outer periphery of the rotor changes stepwise between two opposing points of the rotor; the conductive pattern is formed into a pulse train shape corresponding to the stepwise changes of the magnetic field strength; and each time the rotor of the sensorless spindle motor makes one rotation, magnetized states of the plural magnetizing parts and the pulse train shape of the conductive pattern are brought into coincidence, at which time one index signal is delivered from the conductive pattern. By this construction, the index detection mechanism using no hole element can be obtained, so that the apparatus can be miniaturized.

### BRIEF DESCRIPTION OF THE DRAWINGS

Preferred embodiments of the present invention will be described in detail based on the followings, wherein:

FIGS. 1A and 1B are drawings showing the configuration of major portions of an index detection mechanism of the present invention;

FIG. 2 is a signal waveform diagram showing an example of an index signal outputted from the index detection mechanism shown in FIG. 1;

FIGS. 3A to 3C are drawings showing the configuration of major portions of two examples of known rotation control mechanisms in a spindle motor; and

FIGS. 4A to 4C are drawings showing the configuration of major portions of another example of known rotation control mechanisms in a spindle motor.

### DESCRIPTION OF PREFERRED EMBODIMENTS

Hereinafter, embodiments of the present invention will be described with reference to the accompanying drawings.

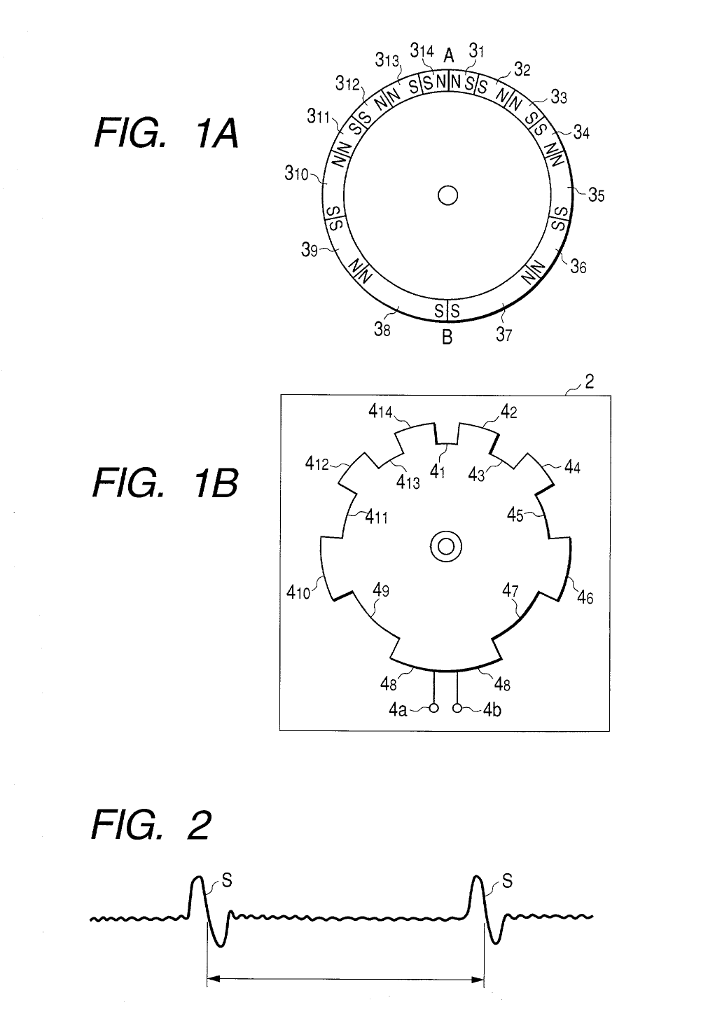

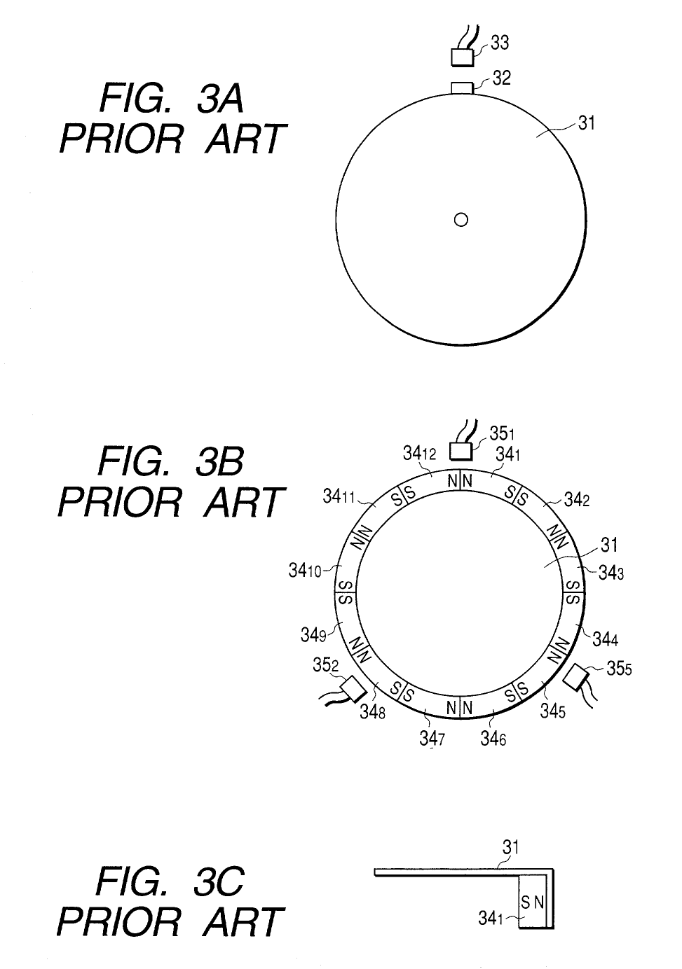

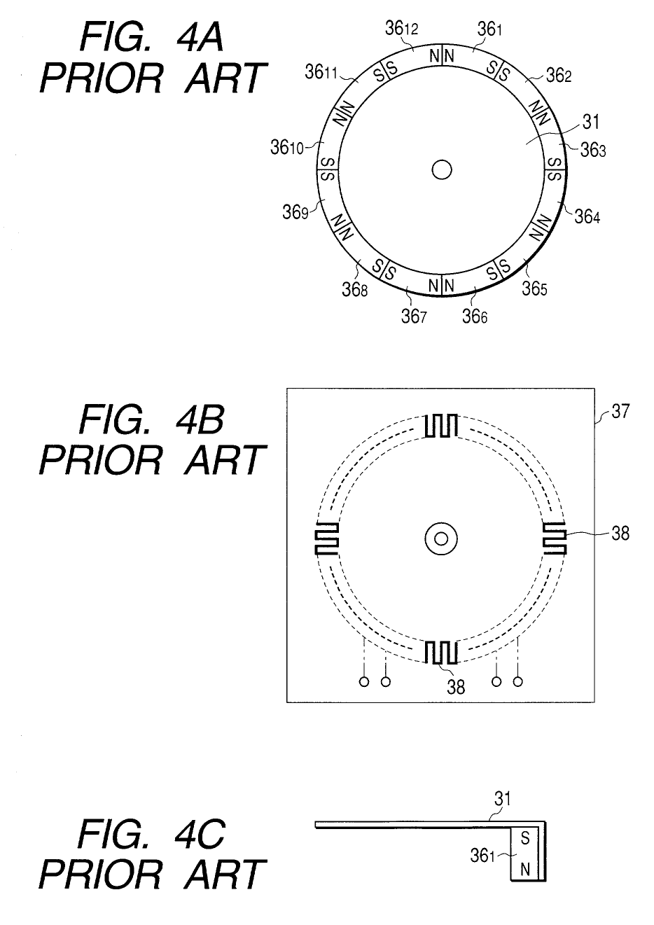

FIGS. 1A and 1B are drawings showing a configuration of major portions of an index detection mechanism of the present invention: FIG. 1A is a diagram showing the configuration of magnetizing parts provided on a rotor face of a sensorless spindle motor; and FIG. 1B is a drawing showing the configuration of conductive patterns provided on a substrate disposed in opposed relation to the rotor face.

As shown in FIGS. 1A and 1B, the index detection mechanism of this embodiment comprises: a rotor 1 of a sensorless spindle motor; a substrate 2 disposed in opposed relation to the rotor 1; plural magnetizing parts 3₁ 3₂, . . . , 3₁₂, 3₁₃, and 3₁₄ successively formed on the bottom of an outer periphery of one face of the rotor 1; a conductive pattern 4 of pulse train shape formed on the substrate 2; and signal delivery terminals 4a and 4b formed on the substrate 2.

In this case, the magnetizing parts 3₁ to 3₁₄ are formed so that the magnetizing polarities of adjacent portions of two adjacent magnetizing parts are the same and the lengths of the magnetizing parts 3₁ to 3₁₄ in a circumferential direction become stepwise longer in a direction from point A to point B, two points in opposed relation on a diagonal line. To be more specific, the lengths of the magnetizing parts 3₁ and 3₁₄ nearest to the point A in the circumferential direction are the shortest, the lengths of the magnetizing part 3₂ to 3₁₃ adjacent to them in the circumferential direction are the next shortest, followed by the lengths of the magnetizing parts 3₃ and 3₁₂, magnetizing parts 3₄ and 3₁₁, magnetizing parts 3₅ and 3₁₀, and magnetizing parts 3₆ and 3₉, which become stepwise longer in the circumferential direction in that order; the lengths of the magnetizing parts 3₇ and 3₉ nearest to the point B in the circumferential direction are the longest; and the magnetic field strength of the magnetizing parts 3₁ to 3₁₄ in the circumferential direction becomes stepwise weaker in a direction from the point A to point B.

The conductive pattern 4 of pulse train shape is connected to signal delivery terminals 4a and 4b at each end and is formed into a pulse train shape corresponding to the magnetizing states of the magnetizing parts 3₁ and 3₁₄. To be more specific, the conductive pattern 4 is formed by: a negative polarity portion 4₁ including adjacent portions of the two magnetizing parts 3₁ and 3₁₄; a positive polarity portion 4₂ including adjacent portions of the two magnetizing parts 3₁ and 3₂; a negative polarity portion 4₃ including adjacent portions of the two magnetizing parts 3₂ and 3₃; a positive polarity portion 4₄ including adjacent portions of the two magnetizing parts 3₃ and 3₄; a negative polarity portion 4₅ including adjacent portions of the two magnetizing parts 3₄ and 3₅; a positive polarity portion 4₆ including adjacent portions of the two magnetizing parts 3₅ and 3₆; a negative polarity portion 4₇ including adjacent portions of the two magnetizing parts 3₆ and 3₇; a positive polarity portion 4₈ including adjacent portions of the two magnetizing parts 3_{7 and 3}₈; a negative polarity portion 4₉ including adjacent portions of the two magnetizing parts 3₈ and 3₉; a positive polarity portion 4₁₀ including adjacent portions of the two magnetizing parts 3₉ and 3₁₀; a negative polarity portion 4₁₁ including adjacent portions of the two magnetizing parts 3₁₀ and 3₁₁; a positive polarity portion 4₁₂ including adjacent portions of the two magnetizing parts 3₁₁ and 3₁₂; a negative polarity portion 4₁₃ including adjacent portions of the two magnetizing parts 3₁₂ and 3₁₃; and a positive polarity portion 4₁₄ including adjacent portions of the two magnetizing parts 3₁₃ and 3₁₄. The lengths of the negative polarity portions 4₁, 4₃, 4₅, 4₇, 4₉, 4₁₁, and 4₁₃ in the circumferential direction, and the lengths of the positive polarity portions 4₂, 4₄, 4₆, 4₈, 4₁₀, 4₁₂ and 4₁₄ in the circumferential direction are respectively set as the magnetic field strength of the magnetizing parts 3₁ to 3₁₄ in the circumferential direction becomes stepwise weaker in a direction from the point A to point B.

By the way, of the lengths of the negative polarity portions 4₁ to 4₁₃ in the circumferential direction, the negative polarity portion 4₁ is the shortest, the negative polarity portions 4₃ and 4₁₃ are the next shortest, and the negative polarity portions 4₅ and 4₁₁, and the negative polarity portions 4₇ and 4₉ are longer in that order. Of the lengths of the positive polarity portions 4₂ to 4₁₄ in the circumferential direction, the positive polarity portions 4₂ and 4₁₄ is the shortest, the positive polarity portions 4₄ and 4₁₂ are the next shortest, and the positive polarity portions 4₆ and 4₁₀, and the positive polarity portions 4₈ are longer in that order. The positive polarity portion 4₈, is split to two portions midway, where signal delivery terminals 4a and 4b are disposed for connection.

FIG. 2 is a signal waveform diagram showing an example of an index signal outputted from the index detection mechanism shown in FIGS. 1A and 1B.

In FIG. 2, a vertical axis represents amplitude and a horizontal axis represents time, and S designates an index signal generated each time the sensorless spindle motor makes one rotation.

The operation of the index detection mechanism configured as described above will be described using FIGS. 1A and 1B, and FIG. 2.

When the sensorless spindle motor is rotationally driven and the rotor 1 rotates accordingly, the magnetizing parts 3₁ to 3₁₄ formed on the bottom of an outer periphery of one face of the rotor 1 rotate along with the rotor 1. At this time, in the conductive pattern 4 of pulse train shape formed on the substrate 2, when adjacent same polarity portions of adjacent magnetizing parts near, a position control signal (counter electromotive force) having a relatively large amplitude is generated in one of the positive polarity portions 42 to 4₁₄ or negative polarity portions 4₁ to 4₁₃ of the conductive pattern 4 to which the same polarity portions near, while, when adjacent same polarity portions of adjacent magnetizing parts are moving away, a position control signal (counter electromotive force) having a relatively small amplitude is generated in one of the positive polarity portions 4₂ to 4₁₄ or negative polarity portions 4₁ to 4₁₃ of the conductive pattern 4 from which the same polarity portions are moving away.

In this case, if the rotation speed of the sensorless motor is constant, since a cycle at which adjacent same polarity portions of adjacent magnetizing parts near is formed so that the lengths of the magnetizing parts 3₁ to 3₁₄ in the circumferential direction successively change stepwise, that is, the cycle is formed so as to repeatedly become regularly successively long or successively short, when the positions of the positive polarity portions 4₂ to 4₁₄ and negative polarity portions 4₁ to 4₁₃ of the conductive pattern 4 corresponding to the positions of the magnetizing parts 3₁ to 3₁₄ coincide with the repetition of such a cycle, that is, each time the sensorless spindle motor makes one rotation, position control signals (counter electromotive force) generated in the positive polarity portions 4₂ to 4₁₄ and the negative polarity portions 4₁ to 4₁₃ are serially added to each other, with the result that a position control signal (counter electromotive force) having a large amplitude is obtained in the whole of the conductive pattern 4, and an index signal S is taken out as a position control signal from the signal delivery terminals 4a and 4b, as shown in FIG. 2.

On the other hand, when the positions of the positive polarity portions 4₂ to 4₁₄ and the negative polarity portions 4₁ to 4₁₃ do not coincide with the repetition of such a cycle, even if position control signals (counter electromotive force) generated in the positive polarity portions 4₂ to 4₁₄ and/or the negative polarity portions 4₁ to 4₁₃ are added to each other in a part of the conductive pattern 4, since position control signals (counter electromotive force) generated in other parts of the positive polarity portions 4₂ to 4₁₄ and/or the negative polarity portions 4₁ to 4₁₃ are not added to each other, a signal generated has a level as low as a noise level, which is considerably lower than the level of the index signal S, and at this point, no index signal S is outputted.

According to the index signal detection mechanism of this embodiment, since an index signal is delivered from the conductive pattern 4 each time the rotor of the sensorless spindle motor makes one rotation, magnetic sensors such as relatively large hole elements as used in the known sensorless spindle motor control system need not be used, so that apparatuses having the sensorless spindle motor can be miniaturized.

In the sensorless spindle motor control system having the index signal detection mechanism of this embodiment, although an example of not providing the rotation smoothing control mechanism is shown, where the rotation smoothing control mechanism is required, it may be provided, in addition to the index signal detection mechanism.

As has been described above, according to the present invention, plural successive magnetizing parts are formed on the bottom of an outer periphery of a rotor face of a sensorless spindle motor; a conductive pattern of pulse train shape is formed on a substrate disposed in the proximity of the rotor face in opposed relation to the plural magnetizing parts; the plural magnetizing parts are formed so that magnetic field strength in the direction of an outer periphery of the rotor changes stepwise between two opposing points of the rotor; the conductive pattern is formed into a pulse train shape corresponding to the stepwise changes of magnetic field strength; and each time the rotor of the sensorless spindle motor makes one rotation, magnetized states of the plural magnetizing parts and the pulse train shape of the conductive pattern are brought into coincidence, at which time one index signal is delivered from the conductive pattern. This construction provides the effect that the index detection mechanism using no hole element can be obtained, so that the apparatus can be miniaturized.

What is claimed is:

1. An index detection mechanism which forms plural successive magnetizing parts on a bottom of an outer periphery of one face of a rotor of a sensorless spindle motor, forms a conductive pattern of pulse train shape on a substrate disposed in proximity of the one face of the rotor in opposed relation to the plural magnetizing parts, detects magnetic flux changes caused by rotations of the plural magnetizing parts during rotations of the rotor as counter electromotive force in the conductive pattern of pulse train shape, and delivers the detected output as an index signal, wherein the plural magnetizing parts are formed so that magnetic field strength in a direction of an outer periphery of the rotor changes stepwise between two opposing points of the rotor, wherein the conductive pattern is formed into a pulse train shape corresponding to the stepwise changes of the magnetic field strength, and wherein one index signal is delivered from the conductive pattern each time the rotor makes one rotation.
